(19) United States
(12) Patent Application Publication
(10) Pub. No.: US 2013/0106574 A1
(43) Pub. Date: May 2, 2013

(54) SIGN AND SYSTEM FOR DISPLAY OF ENVIRONMENTAL CONDITIONS

(71) Applicant: Bradley Robert KYBERD, Victoria (AU)

(72) Inventor: Bradley Robert KYBERD, Victoria (AU)

(73) Assignee: Adco International Pty Ltd., Victoria (AU)

(21) Appl. No.: 13/418,913

(22) Filed: Mar. 13, 2012

(30) Foreign Application Priority Data
Oct. 26, 2011 (AU) 2011904416

(51) Int. Cl. G08B 5/22; G01D 13/00; G01D 11/28

(52) U.S. Cl. 340/6.1; 116/286; 116/284

(57) ABSTRACT

A sign (10) for display of an environmental condition, including a display surface (12) having at least one scale (16) indicating levels (16.1 to 16.6) of the environmental condition. At least one indicator (14) is provided which is movable over the at least one scale (16) to provide a visual indication of a predetermined level (16.1 to 16.6) of the environmental condition. Control means (202 to 208) are provided for moving the indicator(s) (14) over the scale(s) (16). The control means (202 to 208) includes a remote device management module (202) which is controllable from a remote location (110, 120) over a wireless data network (100) to move the indicator(s) (14) to the predetermined level (16.1 to 16.6). The present invention also provides a corresponding system for display of an environmental condition.

### TECHNICAL FIELD

The present invention relates to a sign and a system for display of environmental conditions.

### BACKGROUND

In some locales, there is an increased risk of extreme environmental conditions such as fire or flooding. An important role for emergency services and other government agencies in such locales is to communicate extreme conditions to members of the public. For example, bushfires are a common occurrence in rural areas of Australia, and it is critical that fire authorities be able to warn the public of fire danger at times of high risk.

While information regarding fire or weather conditions is generally readily available to the public in urban areas, those resident in or travelling through more remote areas may not have access to such information. For this reason, local fire authorities in remote areas employ roadside fire danger signs to communicate the day's maximum fire danger level to passing motorists. The maximum fire danger level is generally forecast by a meteorological authority and is based on parameters such as seasonal dryness, amount and duration of rainfall, air temperature and relative humidity, and wind speed.

Known roadside fire danger signs include an indicator needle attached to a board having a number of coloured segments, each of which corresponds to a different fire danger level, increasing in severity from left to right. The needle is moved on a daily basis to overlie the appropriate segment depending on that day's fire danger forecast.

It would be desirable to overcome or alleviate one or more problems of known fire danger signs, or at least to provide a useful alternative.

### SUMMARY OF THE INVENTION

In a first aspect, the present invention provides a sign for display of an environmental condition, including: a display surface having at least one scale indicating levels of the environmental condition; at least one indicator which is movable over the at least one scale to provide a visual indication of a predetermined level of the environmental condition; and, control means for moving the at least one indicator over the at least one scale; wherein the control means includes a remote device management module which is controllable from a remote location over a wireless data network to move the at least one indicator to the predetermined level.

Use of a wireless data network to control the indicator position permits the process of updating the status of the environmental condition to be conducted remotely and in an automated fashion. This can be done from a single location, as frequently as desired, and for more than one sign and/or scale.

The wireless data network may be a cellular network, for example.

The sign may further include at least one electronic display means operably coupled to the control means. Advantageously, the display of data on the at least one electronic display means and the movement of the indicator(s) may both be carried out using the remote device management module.

The at least one electronic display means may be configured to display data received over the wireless data network.

The at least one electronic display means is preferably an LED display, but can be another type of electronic display, for example a liquid crystal display, OLED display, electroluminescent display or the like. The at least one electronic display means may be used for real-time display of messages related to the environmental condition, for example messages relating to detours which should be taken, areas which should be avoided and the like. The messages may also be unrelated to the environmental condition, and could contain advertising, for example.

In one embodiment, the scale(s) is/are an ordinal scale represented by a plurality of areas on the display surface, each area corresponding to one of the levels of the environmental condition. The areas may be segments of a semicircle. The segments may be coloured.

Preferably, the indicator(s) is/are a needle. The needle may be rotatable about an axis perpendicular to a plane of the sign. Preferably, the needle is drivable by an electric motor. The control means may include drive means for driving the electric motor.

Preferably, the control means includes a programmable logic controller operably coupled to the remote device management module, and if applicable, to the at least one electronic display means and/or the drive means.

The programmable logic controller may store message data for display on the at least one electronic display means. The message data may be location-specific message data.

In one embodiment, the sign further includes a plurality of proximity switches, each proximity switch being associated with one of the plurality of areas.

The environmental condition may be a fire danger rating. Alternatively, the environmental condition may be a flood or storm condition or the like.

The sign may further include an independent power supply. The independent power supply may include a solar collector or a wind turbine.

The sign may further include a plurality of lights, at least one light being associated with each of the plurality of areas. The sign may also include at least one display surface illumination light.

In a second aspect, the invention provides a system for display of an environmental condition, including: a computer system including a wireless network interface controller; computer-readable data storage in communication with the computer system; and, at least one sign according to the first aspect of the invention defined above; wherein the computer-readable data storage includes computer-readable instructions stored thereon which, when executed, cause the computer system to perform the steps of, for the or each said sign: receiving data representative of a predetermined level of the environmental condition; transmitting, over the wireless data network, instructions to the remote device management module to move the at least one indicator to the predetermined level.

These and other essential or preferred features of the present invention will be apparent from the description that now follows.

### BRIEF DESCRIPTION OF THE DRAWINGS

In order that the invention may be more clearly understood and put into practical effect there shall now be described in detail a preferred sign and systems for display of environmental conditions in accordance with the invention. The ensuing description is given by way of non-limitative examples only and is with reference to the accompanying drawings, wherein:

FIG. 1 shows a sign for display of environmental conditions, made in accordance with a preferred embodiment of the present invention;

FIG. 2 is a block diagram of the preferred functional components of the sign of FIG. 1; and,

FIG. 3 is a schematic of a preferred indicator feedback circuit which is suitable for use with the sign of FIG. 1.

### DETAILED DESCRIPTION OF PREFERRED EMBODIMENTS

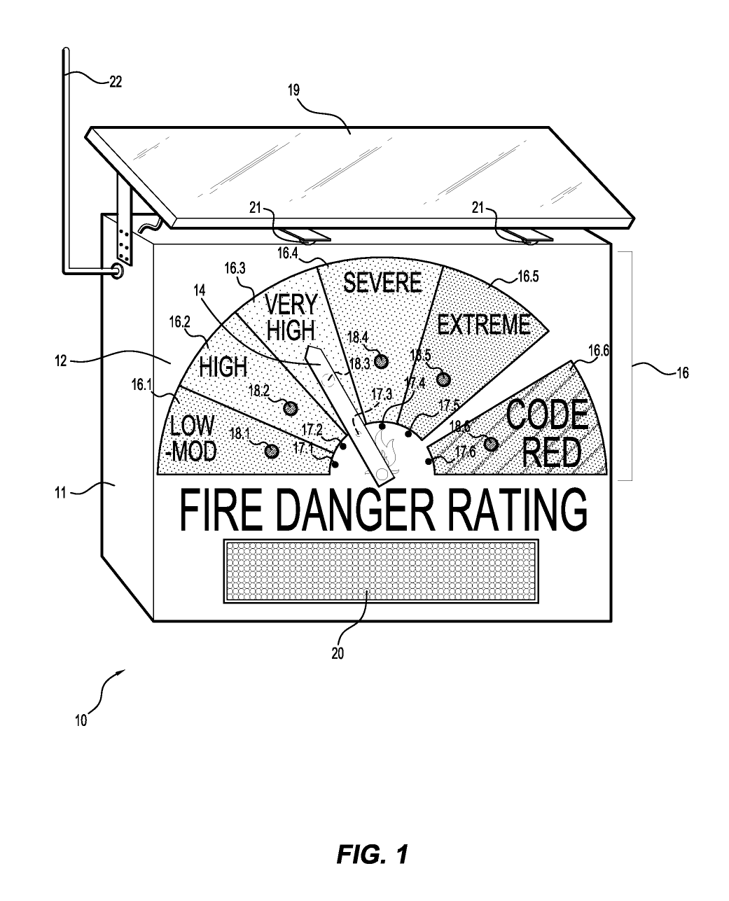

Referring initially to FIG. 1, there is shown a sign 10 for display of an environmental condition, the environmental condition in this example being fire danger rating. Although described hereinafter as being a sign 10 and related system for displaying a fire danger rating, it should be appreciated that signs and systems made in accordance with the present invention are not limited to that use only. The present invention should therefore not be construed as limited to the specific example shown in the drawings.

Sign 10 generally includes a housing 11 having a front panel with a display surface 12. The display surface 12 includes at least one scale 16 comprising a plurality of areas, for example, a semi-circular scale 16 having six coloured areas 16.1 to 16.6 as shown, each area 16.1 to 16.6 being a predefined segment of the preferred semi-circular scale 16.

The plurality of areas 16.1 to 16.6 constitutes an ordinal scale 16 indicating levels of fire danger rating. The fire danger levels and their corresponding coloured segments are preferably as follows:
segment 16.1: low-mod (meaning, low-moderate fire danger rating);
segment 16.2: high;
segment 16.3: very high;
segment 16.4: severe;
segment 16.5: extreme; and,
segment 16.6: code red.

While an ordinal scale 16 having discrete levels for the environmental condition is shown in the embodiment of FIG. 1, it will also be appreciated that an interval scale, or a hybrid ordinal/interval scale, may be used if appropriate for the environmental condition that is to be displayed. The present invention should therefore not be construed as limited to the specific example provided.

Sign 10 preferably includes at least one indicator in the form of a needle 14 which can be moved over scale 16 to provide a visual indication of a predetermined level (for example, user-defined or computer-defined) of the environmental condition. For example, if needle 14 is moved to a position overlying segment 16.4, the predetermined fire danger level is “severe”. It will be appreciated that indicator means other than a needle 14 could also be used in accordance with the present invention. The specific form of indicator means being largely dependent on the form of scale or scales 16 provided on display surface 12.

Each of segments 16.1 to 16.6 preferably has associated with it one of a plurality of proximity sensors 17.1 to 17.6 (the position of proximity sensor 17.3 being obscured in FIG. 1 by needle 14). Proximity sensors 17.1 to 17.6 may be inductive proximity sensors which are triggered by a metallic portion of needle 14 as the metallic portion passes over them. Alternatively, they may be optical or infrared sensors which are triggered by changes in reflectance as needle 14 traverses the beam. A skilled person will appreciate many variations in sensors that could be used to determine the position of needle 14. Accordingly, the present invention should not be construed as limited to the specific examples provided.

The housing 11 of sign 10 may also carry at least one electronic display means 20, preferably in the form of an LED display 20, but could be another type of electronic display, for example a liquid crystal display, OLED display, electroluminescent display or the like. LED display 20 may be used to display messages related to, or even completely independent from, the user/computer-defined level of the environmental condition, as will later be described. For example, LED display 20 could be used for real-time display of messages related to the environmental condition, for example messages relating to detours which should be taken, areas which should be avoided and the like. The messages may also be unrelated to the environmental condition, and could contain advertising, for example.

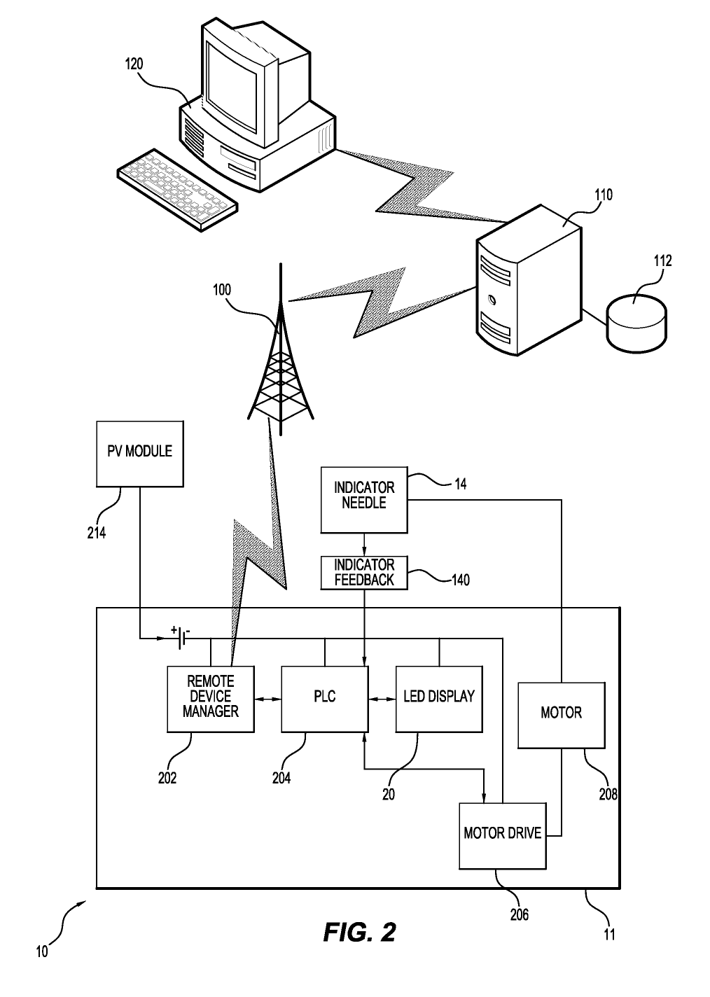

With reference now to FIG. 2, details of the preferred internal components of sign 10, and their relationship with indicator needle 14, scale 16, and LED display 20 are described.

Located within housing 11 of sign 10 are a remote device management module 202, a programmable logic controller (PLC) 204, a motor drive 206 and an electric motor 208 which is connected to, and is driven by, motor drive 206.

Remote device management module 202, PLC 204, and motor drive 206/motor 208 collectively form control means for indicator needle 14 of sign 10.

Electrical components of sign 10 are preferably powered by an independent power supply, which in the preferred embodiment shown in FIG. 2 is a photovoltaic module 214, but which may instead (or as well) include a wind turbine or other alternative source of power.

Indicator needle 14 is coupled to an indicator feedback means 140, which is in turn coupled to PLC 204. Indicator feedback means 140 provides information to PLC 204 regarding the current position of indicator needle 14.

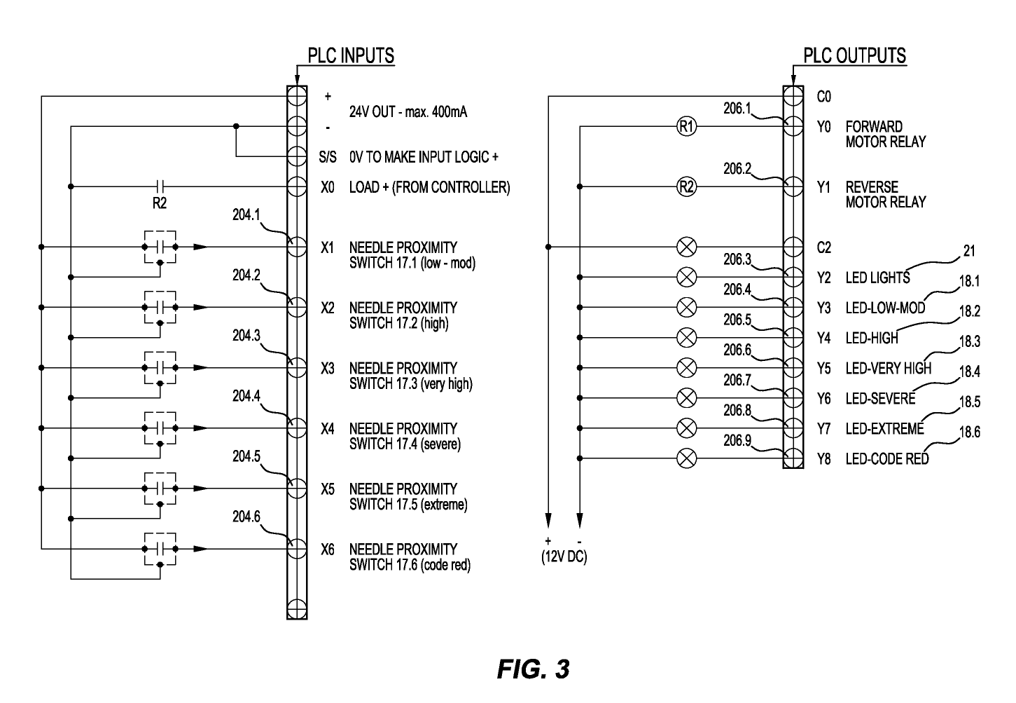

As shown in FIG. 3, indicator feedback means 140 includes proximity sensors 17.1 to 17.6 (FIG. 1) which are coupled to inputs 204.1 to 204.6 respectively of PLC 204. Each proximity sensor 17.1 to 17.6 is in electrical communication with a normally-open relay. Accordingly, when a proximity sensor 17.1 to 17.6 is triggered, its corresponding relay will close and this will be detected at the corresponding input of PLC 204, providing positional information to PLC 204.

If motor 208 is a stepper motor, indicator feedback means 140 may be omitted, since the number of pulses delivered to motor 208 is known a priori, and hence the position of needle 14 could be monitored by PLC 204 without needing feedback. In some embodiments, it may be advantageous to provide indicator feedback means 140 in conjunction with a stepper motor 208. For example, proximity sensors 17.1 and 17.6 could be provided at just the extremities of scale 16 (i.e. at segments 16.1 and 16.6) to monitor when needle 14 reaches either of those points, while the needle 14 position between the extremities could be monitored by counting the number of pulses delivered to stepper motor 208.

Photovoltaic module 214 includes a photovoltaic panel 19 which is located external to housing 11 of sign 10 as shown in FIG. 1, and a photovoltaic charge controller of known type (not shown) which may be housed at least partly within housing 11 of sign 10. The charge controller preferably includes two 12 V batteries (not shown) which are charged by current generated by photovoltaic panel 19. Photovoltaic module 214 is connected to and provides power (at 12V DC) to each of remote device management module 202, PLC 204, LED display 20 and motor drive 206.

PLC 204 may be any suitable PLC, however those manufactured by Fatek Automation Corp have been found to be particularly well suited to the present embodiment, such as, for example, PLC model numbers FBs-24MCR-D12 or FBs-14MC, each of which include an RS485 port and an RS232 port. The RS485 port is preferably used to interface PLC 204 with remote device management module 202, which in this embodiment is a Netbiter (registered trade mark) EasyConnect EC220 unit manufactured by Intellicom Innovation AB. Similarly, the RS232 port is preferably used to interface PLC 204 with LED display 20. It will be appreciated that any suitable remote device management module 202 could be used in accordance with the present invention. Accordingly, the present invention should not be construed as limited to the specific example provided.

Remote device management module 202 includes a wireless network interface (not shown), for example a GSM/GPRS modem coupled to aerial 22 (see, FIG. 1) which permits remote device management module 202 to communicate over a cellular telephone network 100. Thus, for example, remote device management module 202 can receive instructions from a computer system 110 located at a remote location in order to drive components of sign 10.

Preferably, computer system 110 is preferably a server computer system 110 in communication with computer-readable data storage 112. Computer-readable data storage 112 may be used to store the current position of indicator needle 14 of sign 10. It will also be appreciated that indicator position data for multiple signs 10 can be stored simultaneously. Alternatively, PLC 204 of sign 10 (or of each sign 10, if there is more than one) may store the indicator position data, and communicate the indicator position data to server computer system 110 via remote device management module(s) 202.

Server computer system 110 may be configured to receive incoming network connections (either wired or wireless) from a client computer system 120, such that a user at client computer system 120 can interact with remote device management module 202 via server computer system 110.

To set the indicator position (needle 14 position) of sign 10, server computer system 110 first receives status data representative of the current level of the environmental condition from client computer system 120. The data may be generated based on input of information relating to the current level by a user of client computer system 120 into a user interface. Alternatively, the data representing the current level may be retrieved from another server computer system (not shown), responsible for maintaining the status data, for server computer system 110 without requiring manual input.

Once the status data are received, server computer system 110 translates the data to a position along the scale 16 on display surface 12 of sign 10, and sends a request to remote device management module 202 to move indicator needle 14 to that position. Optionally, server computer system 110 may compare the position to the current (stored) position of indicator needle 14 to determine, prior to sending the request, if any movement is needed at all, and if so, in which direction the indicator needle 14 should be moved. Alternatively, this comparison may be performed by PLC 204.

For example, suppose that indicator needle 14 is currently at segment 16.2, indicating that the current fire danger level is “high”. If it is desired to update the fire danger level to “extreme”, server computer system 110 requests remote device management module 202 to instruct PLC 204 to move needle 14 forward to segment 16.5 (from segment 16.2). PLC 204 closes a normally-open forward motor relay coupled to one of its outputs 206.1, which is also coupled to motor drive 206, thereby actuating motor 208 such that it moves in the forward direction (i.e., to the right in FIG. 1). PLC 204 keeps the forward motor relay closed until it detects, via indicator feedback means 140, that indicator needle 14 has triggered proximity sensor 17.5 (coupled to input 204.5) of segment 16.5. Similarly, if it was then desired to move the indicated fire danger level back to “low-moderate”, server computer system 110 would request movement of indicator needle 14 in reverse to segment 16.1 (from segment 16.5), resulting in PLC 204 closing a normally-open reverse motor relay coupled to another of its outputs 206.2. PLC 204 then keeps the reverse motor relay closed until it detects, again via indicator feedback means 140, that indicator needle 14 has triggered proximity sensor 17.1 (coupled to input 204.1) of segment 16.1.

As discussed above, if motor 208 is a stepper motor, the position of indicator needle 14 can be monitored by PLC 204 without needing feedback. Accordingly, if the initial position of indicator needle 14 is known, the number of pulses required to be delivered to motor 208 to move needle 14 in either the forward or reverse direction to the desired position along scale 16 can be calculated (for example, by PLC 204). The triggering of proximity sensors 17.1 to 17.6 could be used as a cross-check if desired.

Preferred LED display 20 may display a variety of messages. These may be conveyed from server computer system 110 (either directly, or after receipt of instructions from client computer system 120) to remote device management module 202, which in turn sends instructions to PLC 204 to display message data on LED display 20. Remote device management module 202 may substantially simultaneously instruct PLC 204 to move indicator needle 14 to a predetermined position on scale 16, and to display a message on LED display 20. The message may be correlated with the predetermined position on scale 16. For example, if indicator needle 14 is pointing to segment 16.6, LED display 20 might simultaneously display a message “CODE RED: evacuate area immediately”, which may scroll across LED display 20.

Messages displayed on LED display 20 may be location-specific depending on the geographical position of sign 10. For example, if a particular road is known to be in a densely tree-populated area, LED display 20 may be instructed by PLC 204 to display a message to the effect that that road should be avoided. Location-specific messages may be stored on PLC 204, or alternatively may be stored in a database which is in communication with server computer system 110. In times of low to moderate fire danger, LED display 20 may be used to display advertisements or any other form of message as desired.

To improve the effectiveness and/or visibility of sign 10 (or scale 16), particularly at night or at times during which light conditions are poor, as can be seen in FIG. 1, sign 10 may also include additional lighting components. For example, each of segments 16.1 to 16.6 of scale 16 may include at least one LED segment light 18.1 to 18.6 for illuminating a respective segment 16.1 to 16.6 corresponding to the position of needle 14. This illumination of a segment 16.1 to 16.6 serves as an additional means for passing motorists, etc., to easily determine the position of needle 14, and hence the relative fire danger level. As can be seen in FIG. 3, LED segment lights 18.1 to 18.6 are preferably coupled to outputs 206.4 to 206.9 of PLC 204, and are illuminated when required by the detection of the position of indicator needle 14 by a respective proximity sensor 17.1 to 17.6 coupled to PLC inputs 204.1 to 204.6. In a preferred form, each of LED segment lights 18.1 to 18.6 may be coloured to suit the colour of segments 16.1 to 16.6 of scale 16. For example, segments 16.5 (“extreme”) and 16.6 (“code red”) may each be coloured red, hence each of LED segment lights 18.5 and 18.6 may be red LED lights (or have red diffusers associated therewith) to correspond to those red segment colours 16.5, 16.6. Similarly, green, blue, yellow and orange colours may apply to segments 16.1 to 16.4, respectively, meaning matched coloured LED segment lights 18.1 to 18.4 (or diffusers, etc.) could be provided if desired. Sign 10 may also include a plurality of display surface illumination lights 21 (FIG. 1), such as, for example, suitable white or clear LED lights 21. Display surface illumination lights 21 are preferably coupled to output 206.3 of PLC 204 and may be illuminated: at all times; at times when light conditions are poor or at night; or at selected times as instructed by server or client computer systems 110, 120.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as, an acknowledgment or any form of suggestion that the prior publication (or information derived from it) or known matter forms part of the common general knowledge in Australia or elsewhere.

1. A sign for display of an environmental condition, including:
a display surface having at least one scale indicating levels of the environmental condition;
at least one indicator which is movable over the at least one scale to provide a visual indication of a predetermined level of the environmental condition; and
control means for moving the at least one indicator over the at least one scale;
wherein the control means includes a remote device management module which is controllable from a remote location over a wireless data network to move the at least one indicator to the predetermined level.

2. The sign according to claim 1, further including at least one electronic display means operably coupled to the control means, wherein the at least one electronic display means is configured to display data received over the wireless data network.

3. The sign according to claim 1, wherein the at least one scale is an ordinal scale represented by a plurality of areas on the display surface, each area corresponding to one of the levels of the environmental condition.

4. The sign according to claim 3, wherein the areas are segments of a semicircle.

5. The sign according to claim 4, wherein the segments are coloured.

6. The sign according to claim 1, wherein the at least one indicator is a needle.

7. The sign according to claim 6, wherein the needle is rotatable about an axis perpendicular to a plane of the sign.

8. The sign according to claim 7, wherein the needle is drivable by an electric motor.

9. The sign according to claim 8, wherein the control means includes drive means for driving the electric motor.

10. The sign according to claim 1, wherein the control means includes a programmable logic controller operably coupled to the remote device management module.

11. The sign according to claim 2, wherein the control means includes a programmable logic controller operably coupled to the at least one electronic display means.

12. The sign according to claim 3, further including a plurality of proximity switches, each proximity switch being associated with one of the plurality of areas.

13. The sign according to claim 3, further including a plurality of lights, at least one light being associated with each of the plurality of areas.

14. The sign according to claim 13, wherein the plurality of lights includes at least one display surface illumination light.

15. The sign according to claim 1, wherein the environmental condition is a fire danger rating.

16. The sign according to claim 1, further including an independent power supply.

17. The sign according to claim 16, wherein the independent power supply includes a solar collector or a wind turbine.

18. A system for display of an environmental condition, including:
a computer system configured to connect to a wireless data network;
computer-readable data storage in communication with the computer system; and
at least one sign according to claim 1;
wherein the computer-readable data storage includes computer-readable instructions stored thereon which, when executed, cause the computer system to perform the steps of, for the or each said sign:
receiving data representative of a predetermined level of the environmental condition;
transmitting, over the wireless data network, instructions to the remote device management module to move the at least one indicator to the predetermined level.

19. The system according to claim 18, wherein the computer-readable data storage further includes instructions which, when executed, cause the computer system to transmit message data to the remote device management module to be displayed on at least one electronic display means.

20. The system according to claim 19, wherein the message data relates to the predetermined level of the environmental condition.
